(19) United States
(12) Patent Application Publication
(10) Pub. No.: US 2014/0263759 A1
(43) Pub. Date: Sep. 18, 2014

(54) NOZZLE SYSTEM AND METHOD FOR MANUFACTURING COMPOSITE SANDWICH PANELS

(71) Applicant: MILLPORT ASSOCIATES S.A., City of Panama (PA)

(72) Inventor: Ulrich Schwartau, Port d Andratx (ES)

(73) Assignee: MILLPORT ASSOCIATES S.A., City of Panama (PA)

(21) Appl. No.: 13/826,025

(22) Filed: Mar. 14, 2013

(51) Int. Cl. B05B 1/20

(52) U.S. Cl. CPC B05B 1/20
USPC 239/557; 239/565

(57) ABSTRACT

A nozzle and system for manufacturing composite sandwich panels, including an input port configured to receive a fluidic production material for forming a composite sandwich panel; a branching element coupled to the input port, wherein the production material that enters the branching element is output from a first end and a second end of the branching element; and an elongate tubular member coupled to the first end and the second end of the branching element for receiving the production material, wherein the elongate tubular member has a first end; a second end and a plurality of openings formed in the elongate tubular member such that the received production material is output through the plurality of openings. In another embodiment, the nozzle includes a second plurality of openings formed in the elongate tubular member.

### TECHNICAL FIELD OF THE INVENTION

The present invention relates generally to manufacturing equipment, and more particularly, to a nozzle and system for manufacturing composite sandwich panels.

### DESCRIPTION OF THE RELATED ART

There is an increasing global demand for lower-cost buildings such as houses, warehouses and office space. The demand for lower cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In other areas of the world, poverty may make it too costly for people to build houses or other buildings with conventional materials.

The demand for lower-cost housing also is high in areas afflicted by war or natural disasters, such as hurricanes, tornados, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials and may be scarce or expensive to obtain. Thus, there exists a need for alternative materials and techniques for constructing buildings that use advanced material technologies to increase the speed of construction and also reduce or lower ownership costs. Likewise a need exists for increasing manufacturing efficiencies associated with the production of such prefabricated or preassembled components.

### SUMMARY

The present invention relates to a nozzle and a system for producing composite sandwich panels, wherein production materials (e.g., resin, hardener, etc.) are applied during the manufacturing process through the nozzle. As discussed below, production materials may be applied to the composite sandwich panel by spraying the mixture through the nozzle. In one embodiment, the nozzle has a number of openings or holes for the mixture of resin and hardener to be sprayed through. The openings may be configured in a single row or multiple rows. In embodiments having multiple rows, the openings from row may be aligned with another row and/or offset from an adjacent row.

Buildings, such as houses, commercial buildings, warehouses, or other structures can be constructed by composite sandwich panels (also referred to as “sandwich panels” or “composite panels” or “panels”), which have an insulative core and one or more outer layers, for example, layers of laminate. The buildings can be constructed by gluing several sandwich panels together, and usually traditional fasteners, such as screws, rivets, nails, etc., are not needed for such connections.

Generally, composite sandwich panels offer a greater strength-to-weight ratio than traditional materials that are used by the building industry. The composite sandwich panels are generally as strong as, or stronger than, traditional materials including wood-based and steel-based structural insulation panels, while being lighter in weight. Because they weigh less than traditional building materials, the handling and transport of composite sandwich panels is generally less expensive. The composite sandwich panels also can be used to produce light-weight structures, such as floating houses, mobile homes, or travel trailers, etc.

Sandwich panels generally are more elastic or flexible than conventional materials such as wood, concrete, steel or brick and, therefore, monolithic (e.g., unitary or single unit structure) buildings made from sandwich panels generally are more durable than buildings made from conventional materials. For example, sandwich panels also may be non-flammable, waterproof, very strong and durable, and in some cases able to resist hurricane-force winds (up to 300 Kph (kilometers per hour) or more). The sandwich panels also may be resistant to the detrimental effects of algae, fungicides, water, and osmosis. As a result, buildings constructed from sandwich panels may be better able to withstand earthquakes, floods, tornados, hurricanes, fires and other natural disasters than buildings constructed from conventional materials.

Sandwich panel structures may be less expensive to build than structures built from conventional materials because of reduced material costs and alternative construction techniques. The ownership and maintenance costs for sandwich panel structures also may be less over the long term because sandwich panel structures may last longer and degrade at a slower rate than buildings made from conventional materials. Structures built from sandwich panels therefore may require less maintenance and upkeep than structures built from conventional building materials, which may reduce the overall ownership costs for end users.

The insulative core of the sandwich panels also may reduce the amount of energy needed to heat and/or cool the building, which may reduce the overall costs to operate the building. The insulative core also may reduce or eliminate the need for additional insulation in the building, as may be necessary to insulate structures built from conventional building materials. Sandwich panel structures therefore may be less expensive to build and operate than buildings constructed from conventional building materials.

Sandwich panels are generally constructed from one or more outer layers of laminate material and an insulative core. The outer layers of laminate may be formed from one or more layers of reinforcement material. Multiple layers of reinforcement material may be bonded together to form the laminate and to increase the strength and/or rigidity of the laminate and the sandwich panel.

A method can be used to form laminate out of multiple layers of reinforcement material to add strength and/or rigidity to the sandwich panel. The laminate may be formed by stacking two layers of reinforcement material on top of one another, wherein the first layer has a first glass fiber orientation and a second layer has a second glass fiber orientation. The first layer and the second layer may impregnated with a resin and connected together to form a laminate having a combination of the first and second glass fiber orientations.

One aspect of the invention relates to a nozzle for manufacturing composite sandwich panels, the nozzle including: an input port configured to receive a fluidic production material for forming a composite sandwich panel; a branching element coupled to the input port, wherein the production material that enters the branching element is output from a first end and a second end of the branching element; and an elongate tubular member coupled to the first end and the second end of the branching element for receiving the production material, wherein the elongate tubular member has a first end, a second end and a plurality of openings formed in the elongate tubular member such that the received production material is output by dropping through the plurality of openings.

Another aspect of the invention relates to the input port and the branching element being integrally formed.

Another aspect of the invention relates to the input port and the branching element being releasably connected.

Another aspect of the invention relates to the input port and the branching element being welded together.

Another aspect of the invention relates to the elongate tubular member welded to the first end and the second end of the branching element in a manner that allows the production material to flow from input port through the branching element and out the plurality of openings.

Another aspect of the invention relates to the at least one of the input port, the branching element or the elongate tubular member being made of copper pipe.

Another aspect of the invention relates to at least one of the input port, the branching element or the elongate tubular member is made of polyvinyl chloride pipe.

Another aspect of the invention relates to the plurality of openings being linearly spaced apart a first predetermined distance.

Another aspect of the invention relates to the first predetermined distance being less than or equal to 10 millimeters.

Another aspect of the invention relates to the first predetermined distance being substantially about 5 millimeters.

Another aspect of the invention relates to a second plurality of openings being formed in the elongate tubular member, wherein the second plurality of openings are linearly spaced apart a second predetermined distance.

Another aspect of the invention relates to the second predetermined distance is substantially the same as the first predetermined distance.

Another aspect of the invention relates to the second predetermined distance being different than the first predetermined distance.

Another aspect of the invention relates to the second plurality of openings are configured substantially parallel to the first plurality of openings.

Another aspect of the invention relates to the first plurality of openings form a first line and the second plurality of openings form a second line, wherein the first line and the second line are non-intersecting or over-lapping.

Another aspect of the invention relates to the first plurality of openings are offset from the second plurality of openings.

Another aspect of the invention relates to a system for forming a composite sandwich panel, the system including: a mixing manifold having a plurality of input ports for receiving production materials and at least one output port for outputting the production material that enters the mixing manifold; a static mixer having an input port coupled to the output port of the mixing manifold and an output port; and a nozzle coupled to the output port of the static mixer by a second input port, wherein the nozzle includes a branching element coupled to the second input port, wherein the production materials that enters the branching element are output from a first end and a second end of the branching element; and an elongate tubular member coupled to the first end and the second end of the branching element for receiving the production material, wherein the elongate tubular member has a first end, a second end and a plurality of openings formed in the elongate tubular member such that the received production material is output by dropping through the plurality of openings.

Another aspect of the invention relates to the plurality of openings being linearly spaced apart a first predetermined distance.

Another aspect of the invention relates to the first predetermined distance being less than or equal to 10 millimeters.

Another aspect of the invention relates to the first predetermined distance being substantially about 5 millimeters.

Another aspect of the invention relates to a second plurality of openings formed in the elongate tubular member, wherein the second plurality of openings being linearly spaced apart a second predetermined distance.

Another aspect of the invention relates to the second predetermined distance being substantially the same as the first predetermined distance.

Another aspect of the invention relates to the second predetermined distance is different than the first predetermined distance.

Another aspect of the invention relates to the second plurality of openings being configured substantially parallel to the first plurality of openings.

Another aspect of the invention relates to the first plurality of openings forming a first line and the second plurality of openings form a second line, wherein the first line and the second line are non-intersecting or over-lapping.

Another aspect of the invention relates to the first plurality of openings being offset from the second plurality of openings.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIG. 1 is a front view of a nozzle in accordance with aspects of the present invention.

FIGS. 2-4 are bottom plan views of the nozzle in accordance with aspects of the present invention.

FIG. 5 is an enlarged fragmentary view of the nozzle of FIG. 3 in accordance with aspects of the present invention.

FIG. 6 is an exemplary composite sandwich panel in accordance with aspects of the present invention.

FIG. 7 is a schematic view of an exemplary system for manufacturing composite sandwich panels in accordance with aspects of the present invention.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used only for convenience when referring to the figures. For example, “upward,” “downward,” “above,” or “below” merely describe directions in the configurations shown in the figures. The components can be oriented in any direction and the terminology should therefore be interpreted to include such variations. Furthermore, while described primarily with respect to house construction, it will be appreciated that all of the concepts described herein are equally applicable to the construction of any type building, such as warehouses, commercial buildings, factories, apartments, etc.

The present invention is described herein with respect to a system and method for applying resin and hardener through a nozzle for manufacturing a composite sandwich panel. However, it will be appreciated that the system and method may be used for other purposes, e.g., for manufacturing other products.

Referring to FIG. 1, an exemplary nozzle 10 in accordance with aspects of the present invention is illustrated. The nozzle 10 may be used for manufacturing composite sandwich panels. For example, the nozzle may be used to apply resin, hardener or other materials to one or more outer layers of the sandwich panel (e.g., an outer layer of glass fiber used to form an outer layer of the composite sandwich panel).

The nozzle 10 includes an input port 12 configured to receive fluidic production materials (e.g., resin, hardener, fire retardant, etc.) for forming composite sandwich panels. For example, the fluidic production materials include, e.g., resin 102 (FIG. 7), hardener 104 (FIG. 7), flame retardant and cleaning solution (not shown), or a combination of such materials.

A branching element 14 is coupled to the input port 12 such that the fluidic solution that enters the branching element 14 is output from a first end 16 and a second end 18. The nozzle 10 further includes an elongate tubular member 20 coupled to the first end 16 and the second end 18 of the branching element 14 for receiving the fluidic solution. The elongate tubular member has a first end 22; a second end 24 and a plurality of openings 26 (illustrated in FIGS. 1-5).

The plurality of openings 26 are formed in the elongate tubular member 20, such that the fluidic solution that enters the elongate tubular member 20 is output through the plurality of openings 26. The openings formed in the elongate tubular member 20 may be formed in any manner, for example, the openings may be formed by inserting a die or drill bit through a portion of the tubular member and removing the debris, etc. The fluidic solution is output by pouring (also referred to interchangeably as “dropping”) the fluidic material through the openings 26 of the nozzle 10. The terms “dropping” and “pouring” are used to distinguish between “spraying”, which requires exposing the fluidic material to air prior to outputting the material through the nozzle. While in certain embodiments, it may be desired to spray the fluidic solution as it is output from the nozzle, aspects of the present invention relate to pouring and/or dropping the fluidic material on one more components of the composite sandwich panel.

The components of the nozzle 10 may be formed from conventional tubing components. For example, the components may be elbow joints (e.g., joints 28, 30); T-couples (e.g., couplers 32, 34, 36); and linear components (e.g., 38, 40, 42, 44, 46). Preferably, the components may be coupled to each other in a conventional manner. The components may be made of any desired material. Suitable materials include steel, copper, polyvinyl chloride, etc. The components may be releasably coupled together and/or fixedly coupled together. For example, if the components are made from PVC, a PVC cement may be used to fixedly couple the components. Likewise, if the components are made from steel or copper, the components may be welded together with an appropriate solder, for example. In cases where it is desirable to releasably connect the components threaded couplings may be used. For example, the input port 12 and the branching element 14 may be permanently connected (e.g., welded together) and/or releasably connected (e.g., joined together by a threaded mechanism or other mechanism).

One of ordinary skill in the art will readily appreciate that two or more components may be integrally formed. For example, the input port 12, T-coupler 32, linear components 38, 40 and elbow joints 28, 30 may be formed from a single component. One of ordinary skill in the art will appreciate that one or more of the components may be combined with any other component. For example, the input port 12 and the branching element 14 may be integrally formed into a single component.

As shown in FIG. 1, the elongate tubular member 20 may be joined to the first end 16 and the second end 18 of the branching element 14 in a manner that allows the fluidic solution to flow from input port 12 through the branching element 14 and out the plurality of openings 26. For example, the elongate tubular member 20 may be welded to the first end 16 and second 18 of the branching element 14.

Fluid that enters input port 12 of the nozzle 10 flows through the branching element 14 and to ends 16 and 18. The fluid then enters the elongate tubular member 20 and is output through the plurality of openings 26 formed in the elongate tubular member. In one embodiment, the output flow of solution from the plurality of openings 26 is uniform. The openings 26 may be any desired size. In one embodiment, each of the plurality of openings has a diameter that is about 1.0 millimeters. The openings 26 may have any desired size and shape (e.g., circle, square, diamond, rectangle, etc.) suitable to carry out the functions described herein.

FIG. 2 illustrates an embodiment of the invention wherein the respective openings 26 formed in the elongate tubular member 20 are linearly spaced apart a distance (D) (e.g., the distance may be predetermined, set based on the desired application, etc.). The distance (D) may be any desirable distance. In one embodiment, the distance (D) is less than or equal to 10 millimeters. In another embodiment, the predetermined distance (D) is about 5 millimeters. As shown in FIG. 2, the openings 26 may be uniformly spaced apart. In certain applications, it may desirable to vary the distance between the openings 26 depending on a variety factors, including for example, the materials being used, the manufacturing process, the application the nozzle will be used in, the fluid output from the nozzle, etc. In such cases, for example, the openings 26 may be uniformly spaced apart along one or more portions of the elongate tubular member 20 and also may be non-uniformly spaced apart along one or more other portions of the elongate tubular member 20. In one embodiment, the nozzle may have 264 strayed holes/openings on the down side of the nozzle, wherein the diameter of the holes is 1 millimeter and the distance between the holes is 5 millimeter from center to center.

FIG. 3 illustrates another embodiment of the invention wherein a second plurality of openings 50 is formed in the elongate tubular member 20. The respective openings 50 may be linearly spaced apart a second distance (D′). The second distance (D′) may be substantially the same as the first distance and/or different than the first distance. As shown in FIG. 3, the second plurality of openings 50 may be configured substantially parallel to the first plurality of openings, such that the first plurality of openings 26 form a first line and the second plurality of openings 50 form a second distinct line, which are non-intersecting or non-over lapping.

As shown in FIG. 3, the first plurality of openings 26 are offset a distance “O” from the second plurality of openings 50. In another embodiment, illustrated in FIG. 4, the first plurality of openings 26 and the second plurality of openings 50 may be substantially aligned.

Referring to FIG. 5, an exploded view of FIG. 3 is provided that illustrates an embodiment of a nozzle. As shown in FIG. 5, a first plurality of openings 26 and a second plurality of openings 50 are illustrated offset a distance “O”. Each of the openings of the first and second plurality of openings is about 1.0 millimeter in diameter. The distance (D) between openings in the first plurality of openings is substantially the same as the distance (D′) between openings in the second plurality of openings. For example, the distances (D, D′) may be about 5.0 millimeters. The distance (L) between lines formed by the first and second plurality of openings may be any desired distance (e.g., about 0.5 millimeters, about 1.0 millimeter, 5 millimeter, etc.). The dimensions mentioned herein are exemplary and it will be appreciated that the dimensions may be larger or smaller as desired for carrying out the functions and/or features of the invention. In one embodiment, the nozzle has on the down side 532 stray holes with a diameter of 1 millimeter. The holes are placed in two rows on top of each other. The distance of the holes in one row is 5 millimeter center to center. The holes may be offset or aligned, as shown in the FIGS. 3 and 4, respectively.

The nozzle 10 disclosed above is used in a system to manufacture composite sandwich panels. Composite sandwich panels, which may be formed from synthetic materials, provide a light-weight and less expensive alternative to conventional raw materials, e.g., wood, concrete, metal, etc. Sandwich panels are usually connected or joined together with a high-strength bonding material, such as epoxy or glue, and conventional materials, such as nails and screws, are not usually needed. The result is a strong and durable monolithic (e.g., single unit) structure, as described further below.

Referring to FIG. 6, an exemplary sandwich panel 60 is illustrated. As used herein, the phrase “sandwich panel” means a panel having two outer layers 62, 64 separated by a core 66. The outer layers 62, 64 of the sandwich panel 60 are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 62, 64 (also referred to as laminates) may be relatively thin with respect to the panel core 66. The outer layers 62, 64 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

It will be appreciated that the outer layers 62, 64 may be made thicker by layering several layers of reinforcement material on top of one another. The thickness of the reinforcement material also may be varied to obtain thicker outer layers 62, 64 with a single layer of reinforcement material. Further, different reinforcement materials may be thicker than others and may be selected based upon the desired thickness or other characteristics of the outer layers.

The panel core 66 separates the outer layers 62, 64 of the sandwich panel 60. The panel core 66 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary panel core materials include honeycomb that can be made of polypropylene, non-flammable impregnated paper or other composite materials. It will be appreciated that these materials insulate the interior of the structure and also reduce the sound or noise transmitted through the panels, e.g., from one outer surface to the other or from an exterior to an interior of a building structure, etc. The panel core 66 may be any desired thickness and may be, for example, 30 mm (millimeters)-100 mm (millimeters) thick; however, it will be appreciated that the core can be thinner than 30 mm (millimeters) or thicker than 100 mm (millimeters) as may be desired. In one embodiment, the core is approximately 40 mm (millimeters) thick.

The outer layers 62, 64 are adhered to the core 66 with the matrix materials, such as the resin mixture. Once cured, the outer layers 62, 64 of the sandwich panel 60 are firmly adhered to both sides of the panel core 66, forming a rigid building element. It will be appreciated that the resin mixture also may include additional agents, such as, for example, flame retardants, mold suppressants, curing agents, hardeners, etc. Coatings may be applied to the outer layers 62, 64, such as, for example, finish coats, paint, ultraviolet (UV) protection, water protection, etc.

The panel core 66 may provide good thermal insulation properties and structural properties. The outer layers 62, 64 may add to those properties of the core and also may protect the panel core 66 from damage. The outer layers 62, 64 also may provide rigidity and support to the sandwich panel 60.

The sandwich panel 60 may include a first edge 68, a second edge 70, a third edge 72 and a fourth edge 74. The sandwich panels may be any shape and size. In one embodiment, the sandwich panels are rectangular in shape and may be several meters, or more, in height and width. The sandwich panels also may be other shapes and sizes. The combination of the panel core 66 and outer layers 62, 64 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 6) and 1 tons per square meter in the horizontal direction (indicated by arrows H in FIG. 6). The sandwich panels may have other strength characteristics as will be appreciated in the art.

Internal stiffeners may be integrated into the panel core 66 to increase the overall stiffness of the sandwich panel 60. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of about 15 cm (centimeters), 25 cm, 50 cm, or 100 cm. Alternatively, the stiffeners may be placed at different angles, such as a 45-degree angle with respect to the top and bottom of the panel, or at another angle, as may be desired.

Referring to FIG. 7, a system 100 for providing raw materials for the manufacture of sandwich panels is illustrated. The system 100 includes one or more storage containers 102 and 104 for supplying production materials to a mixing manifold 106. As illustrated, the mixing manifold 106 includes corresponding ports (e.g., ports 108, 110) coupled to the storage containers. The ports (108, 110) may be controlled by a computer or otherwise controlled to allow the proper flow of materials (e.g., flow rate) into the mixing manifold 106. For example, during production of sandwich panels, it may be desirable to allow resin stored in container 102 to enter the mixing manifold 106. At another time, it may be desirable to allow hardener stored in container 104 to enter the mixing manifold 106.

During the manufacturing process, e.g., applying resin and/or hardener over glass particles that may form the outer layers, the mixing manifold 106 may contain components of resin, hardener and/or flame retardant (referred herein individually and/or collectively as “production materials”). The production materials may be applied by dropping such material(s) in liquid form through the nozzle over the top of a production table 112 containing a portion of the sandwich panel. For example, the production materials may have a high viscosity and may be dropped through the nozzle 10 over one or more of the outer layers of the composite sandwich panel at a desired temperature (e.g., 42° C.). Such application takes place by the flow of production material from the mixing manifold 106 and the static mixer 114 through the nozzle 10. As shown in FIG. 7, the static mixer 114 has an input port coupled to the output port of the mixing manifold 106. The static mixer 113 also has an output port coupled to the nozzle 10.

From the nozzle 10, the production materials may be applied with pressure (e.g., fluid pump) and/or allowed to flow assisted by gravity through the nozzle 10 onto the production table 112 and/or one or more portions of the sandwich panel 60. For example, the nozzle may be used to drop the production materials on the top of the glass fiber used to form one or more outer layers 62, 64 of the sandwich panel 60. While the production materials may also be sprayed onto one or more components of the sandwich panel, the production materials are generally dropped/poured onto the one or more components of the sandwich panel, without the addition of air to the production materials.

The system 100 is a dropping system that drops/pours production materials onto the one or more components of the sandwich panel, as opposed to a spraying system. The effect of mixing the resin with air is undesirable, because the air does not give any strength to the resin material and may actually have deleterious effects (e.g., forming factures, microfractures in one or more layers of the composite sandwich panel. If additional pressure is desired for the application, a fluid pump may be used to generate the additional pressure, without the introduction of air into the production materials.

The production table 112 includes a generally planar or flat surface 112s on which the respective layers of the sandwich panel may be applied or be distributed during the production process. The production table 112 may include a number of additional components, such as a lid or closing mechanism, a vacuum source, a heat source, etc., which may be used during the manufacturing of the sandwich panels and to facilitate panel production.

The resin mixture may be introduced directly via the nozzle 10 from the static mixer 114. A carriage comprising the static mixer 114 and a separate resin container 102, as well as a hardener container 104 and a pumping arrangement, may move across the table 112 in longitudinal direction and output the resin and/or hardener through the nozzle 10 over the table 112. The resin and/or hardener quantity, which is to be applied through the nozzle 10, is controlled via the speed and/or applied pressure (e.g., by a fluid pump).

Although the invention has been shown and described with respect to a certain preferred embodiment or embodiments, it is obvious that equivalent alterations and modifications will occur to others skilled in the art upon the reading and understanding of this specification and the annexed drawings.

What is claimed is:

1. A nozzle for manufacturing composite sandwich panels, the nozzle comprising:
an input port configured to receive a fluidic production material for forming a composite sandwich panel;
a branching element coupled to the input port, wherein the production material that enters the branching element is output from a first end and a second end of the branching element; and
an elongate tubular member coupled to the first end and the second end of the branching element for receiving the production material, wherein the elongate tubular member has a first end; a second end and a plurality of openings formed in the elongate tubular member such that the received production material is output by dropping through the plurality of openings.

2. The nozzle of claim 1, wherein the input port and the branching element are integrally formed.

3. The nozzle of claim 1, wherein the input port and the branching element are releasably connected.

4. The nozzle of claim 1, wherein the input port and the branching element are welded together, and wherein the elongate tubular member welded to the first end and the second end of the branching element in a manner that allows the production material to flow from input port through the branching element and out the plurality of openings.

5. (canceled)

6. (canceled)

7. (canceled)

8. The nozzle of claim 1, wherein the plurality of openings are linearly spaced apart a first predetermined distance.

9. The nozzle of claim 8, wherein the first predetermined distance is less than or equal to 10 millimeters.

10. The nozzle of claim 8, wherein the first predetermined distance is substantially about 5 millimeters.

11. The nozzle of claim 1, further including a second plurality of openings formed in the elongate tubular member, wherein the second plurality of openings are linearly spaced apart a second predetermined distance.

12. (canceled)

13. The nozzle of claim 11, wherein the second predetermined distance is different than the first predetermined distance.

14. The nozzle of claim 11, wherein the second plurality of openings are configured substantially parallel to the first plurality of openings.

15. The nozzle of claim 14, wherein the first plurality of openings form a first line and the second plurality of openings form a second line, wherein the first line and the second line are non-intersecting or over-lapping.

16. The nozzle of claim 15, wherein the first plurality of openings are offset from the second plurality of openings.

17. A system for forming a composite sandwich panel, the system comprising:
a mixing manifold having a plurality of input ports for receiving production materials and at least one output port for outputting the production material that enters the mixing manifold;
a static mixer having an input port coupled to the output port of the mixing manifold and an output port; and
a nozzle coupled to the output port of the static mixer by a second input port, wherein the nozzle includes a branching element coupled to the second input port, wherein the production materials that enters the branching element are output from a first end and a second end of the branching element; and an elongate tubular member coupled to the first end and the second end of the branching element for receiving the production material, wherein the elongate tubular member has a first end; a second end and a plurality of openings formed in the elongate tubular member such that the received production material is output by dropping through the plurality of openings.

18. The system of claim 17, wherein the plurality of openings are linearly spaced apart a first predetermined distance.

19. The system of claim 18, wherein the first predetermined distance is less than or equal to 10 millimeters.

20. The system of claim 18, wherein the first predetermined distance is substantially about 5 millimeters.

21. The system of claim 17, further including a second plurality of openings formed in the elongate tubular member, wherein the second plurality of openings are linearly spaced apart a second predetermined distance.

22. (canceled)

23. The system of claim 21, wherein the second predetermined distance is different than the first predetermined distance.

24. The system of claim 21, wherein the second plurality of openings are configured substantially parallel to the first plurality of openings.

25. The system of claim 24, wherein the first plurality of openings form a first line and the second plurality of openings form a second line, wherein the first line and the second line are non-intersecting or over-lapping.

26. (canceled)
